(19) United States
(12) Patent Application Publication
(10) Pub. No.: US 2018/0240154 A1
(43) Pub. Date: Aug. 23, 2018

(54) MESSAGE BROADCASTING SYSTEM

(71) Applicant: Jen-Shyan Chen, TAIPEI CITY (TW)

(72) Inventor: Jen-Shyan Chen, TAIPEI CITY (TW)

(21) Appl. No.: 15/484,148

(22) Filed: Apr. 11, 2017

(30) Foreign Application Priority Data
Feb. 22, 2017 (CN) 201710095299.7

(51) Int. Cl. G06Q 30/02; H04L 29/08; H04L 12/58

(52) U.S. Cl. CPC G06Q 30/0267; H04L 51/18; H04L 67/125

(57) ABSTRACT

A message broadcasting system includes a remote server, a digital signal input device connected to the remote server, at least one mobile communicating device communicating with the remote server, at least one carrier, and at least one image projecting device configured on the carrier and communicating with the mobile communicating device. The digital signal input device is used for inputting a digital signal into the remote server. The mobile communicating device receives the digital signal from the remote server and sends the digital signal with an order to the image projecting device on the carrier. The image projecting device projects the digital signal on a display area according to the order. Accordingly, the message broadcasting system can be used in advertisement field to obtain advertisement effect with low cost.

### BACKGROUND OF THE INVENTION

### 1. Field of the Invention

This invention relates to a message broadcasting system, and more particularly, to a message broadcasting system with excellent broadcasting or advertising effect.

### 2. Description of the Prior Art

The advertisements are often used for broadcasting the information about the stores, enterprises, and the merchandises. One of various types of advertisement is out-of-home media advertising (OOH). The out-of-home media advertising could be achieved by configuring lightbox, neon light, electrical displayer, or display panel on the road, highway, two sides of the railway, neighborhood of the river, square, or the outside of building. The out-of-home media advertising could also be achieved by mobile advertising such as configuring advertising signs, paintings, or displaying screens on vehicles. The out-of-home media advertising would bring good advertising effect and low cost by choosing the advertising media and the advertising place.

The advertising signs or paintings on the vehicle are monotonous, so that it would not gain further advertising effect even if it caught pedestrians' or drivers' eyes by broadcasting the sounds. Although the sounds are capable of attracting pedestrians' or drivers' attentions, it would make adverse effect if the sounds are too loud or too noisy. The electrical display devices configured on the vehicles are capable of displaying dynamic advertisements to catch pedestrians' or drivers' eyes effectively.

However, the dynamic advertisements are pre-stored in the electrical display device and displayed in a regular order or randomly, and they fail to interact with audience to improve the advertising effect. On the other side, even though the cost of the out-of-home media advertising is lower than those of other types of advertisements, the vehicles is required for advertising, and then the cost is hard to further decreased.

Therefore, it is necessary for a message broadcasting system to achieve a better advertising effect and to decrease the cost at the same time.

### SUMMARY OF THE INVENTION

One object of the present invention is to provide a message broadcasting system for projecting a message or signal in a display area conveniently. According to an embodiment of the invention, the message broadcasting system includes a remote server, a digital signal input device, at least one mobile communicating device, at least one carrier, and at least one image projecting device. The digital signal input device is connected to the remote server. Each of the at least one mobile communicating device communicates with the remote server. Each of the at least one image projecting device is configured on the at least one carrier and communicates with the at least one mobile communicating device. In this embodiment, a user can input a digital signal to the remote server via the digital signal input device, and the at least one mobile communicating device is capable of receiving the digital signal from the remote server. An application program is configured in each of the at least one mobile communicating device to control the at least one mobile communicating device to send an order and the received digital signal. The at least one image projecting device is capable of receiving the order and the digital signal from the at least one mobile communicating device, and projecting the digital signal on a display area according to the order.

According to another embodiment, the digital signal can be one of image file, text file, and video file.

According to another embodiment, the digital signal input device can be one of desktop computer, tablet, and smart phone.

According to another embodiment, an input software is configured in the digital signal input device for inputting the digital signal.

According to another embodiment, an input software is configured in the remote server for the digital signal input device to input the digital signal.

According to another embodiment, the at least one mobile communicating device is one of smart phone, a tablet with communicating function, a smart glasses with communicating function, a smart watch with communicating function, and smart helmet with communicating function.

According to another embodiment, the carrier is one of car, motorcycle, bicycle, unmanned flying vehicle, and wearable object.

According to another embodiment, the at least one display area comprises at least one of ground, wall, ceiling of house, ceiling of car, and projection screen.

According to another embodiment, the at least one image projecting device generates a signal according to the projecting times and the projecting durations, and sends the signal to the at least one mobile communicating device.

According to another embodiment, the at least one mobile communicating sends a notification to the remote server according to the signal, and the remote server checks the projecting times and the projecting durations according to the notification.

According to another embodiment, the at least one mobile communicating device is configured on the at least one carrier and connected to the at least one image projecting device.

According to another embodiment, the at least one carrier, the at least one mobile communicating device, and the at least one image projecting device form at least one smart device, and the least one smart device is one of smart car, smart motorcycle, smart bicycle, and robot

Another object of the present invention is to provide a message broadcasting system for displaying a message. According to an embodiment of the invention, the message broadcasting system includes a remote server, a digital signal input device, at least one mobile communicating device, and at least one displayer. The digital signal input device is connected to the remote server. Each of the at least one mobile communicating device communicates with the remote server. Each of the at least one displayer communicates with the at least one mobile communicating device. In this embodiment, a user can input a digital signal to the remote server via the digital signal input device, and the at least one mobile communicating device is capable of receiving the digital signal from the remote server. An application program is configured in each of the at least one mobile communicating device to control the at least one mobile communicating device to send an order and the received digital signal. The at least one displayer is capable of receiving the order and the digital signal from the at least one mobile communicating device, and displaying the digital signal according to the order.

According to another embodiment, the digital signal can be one of image file, text file, and video file.

According to another embodiment, the digital signal input device is one of desktop computer, tablet, and smart phone.

According to another embodiment, an input software is configured in the digital signal input device for inputting the digital signal.

According to another embodiment, an input software is configured in the remote server for the digital signal input device to input the digital signal.

According to another embodiment, the at least one mobile communicating device is one of smart phone, a tablet with communicating function, a smart glasses with communicating function, a smart watch with communicating function, and smart helmet with communicating function.

According to another embodiment, the at least one displayer is one of LED panel, OLED panel, LCD panel, smart phone with display panel, computer, and television.

According to another embodiment, the at least one displayer generates a signal according to the display times and the display durations, and sends the signal to the at least one mobile communicating device.

According to another embodiment, the at least one mobile communicating sends a notification to the remote server according to the signal, and the remote server checks the display times and the display durations according to the notification.

According to another embodiment, the at least one mobile communicating device and the at least one displayer form at least one smart device.

According to another embodiment, the message broadcasting system further comprises at least one receiving device connected to the at least one displayer. The receiving device communicates with the at least one mobile communicating device to receive the order and the digital signal and to send them to the corresponding displayer.

Another object of the present invention is to provide a message broadcasting system for displaying a message. According to an embodiment of the invention, the message broadcasting system includes a remote server, a digital signal input device, at least one mobile communicating device, and at least one displayer. The digital signal input device is connected to the remote server. Each of the at least one mobile communicating device communicates with the remote server. Each of the at least one displayer communicates with the at least one mobile communicating device and the remote server. In this embodiment, a user can input a digital signal to the remote server via the digital signal input device, and the at least one mobile communicating device is capable of receiving a first signal from the remote server. An application program is configured in each of the at least one mobile communicating device to control the at least one mobile communicating device to send an order according to the first signal. The at least one displayer is capable of receiving the order from the at least one mobile communicating device, receiving the digital signal from the remote server according to the order, and displaying the digital signal according to the order.

According to another embodiment, the at least one displayer generates a second signal according to the display times and the display durations, and sends the second signal to the at least one mobile communicating device.

According to another embodiment, the at least one mobile communicating sends a notification to the remote server according to the second signal, and the remote server checks the display times and the display durations according to the notification.

On the advantages and the spirit of the invention, it can be understood further by the following invention descriptions and attached drawings.

### BRIEF DESCRIPTION OF THE APPENDED DRAWINGS

FIG. 1 is a schematic diagram illustrating a message broadcasting system according to an embodiment of the invention.

FIG. 2 is a schematic diagram illustrating different carriers of the message broadcasting system in FIG. 1.

FIG. 3 is a schematic diagram illustrating a message broadcasting system according to another embodiment of the invention.

FIG. 4 is a schematic diagram illustrating a message broadcasting system according to another embodiment of the invention.

FIG. 5 is a schematic diagram illustrating a message broadcasting system according to another embodiment of the invention.

### DETAILED DESCRIPTION OF THE INVENTION

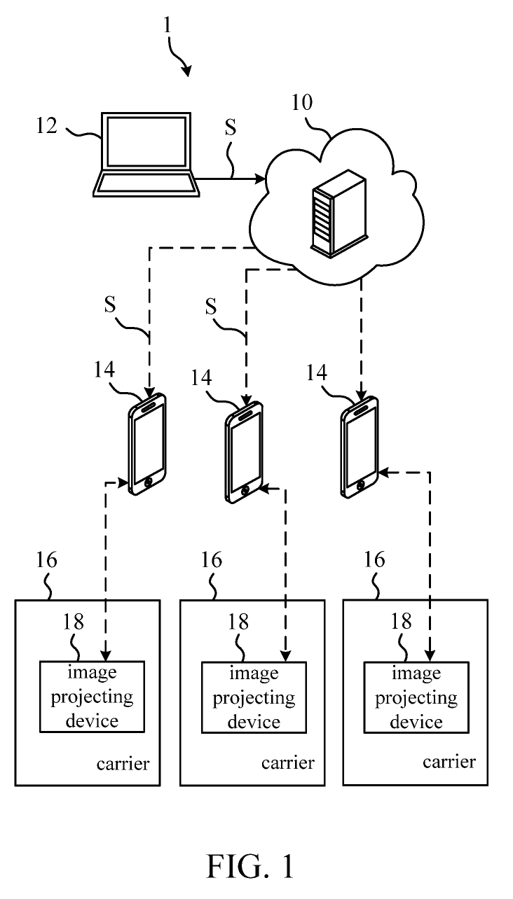

Please refer to FIG. 1. FIG. 1 is a schematic diagram illustrating a message broadcasting system 1 according to an embodiment of the invention. As shown in FIG. 1, the message broadcasting system 1 includes a remote server 10, a digital signal input device 12, at least one mobile communicating device 14, at least one carrier 16, and at least one image projecting device 18. The remote server 10 and the digital signal input device 12 are connected to each other. The remote server 10 and the at least one mobile communicating device 14 communicate with each other. The at least one image projecting device 18 is configured on the at least one carrier 16 and communicates with the at least one mobile communicating device 14.

The digital signal input device 12 is connected to the remote server 10, so that the signal provider can input a digital signal S to the remote server 10 via the digital signal input device 12. The digital signal input device 12 can be one of desktop computer, tablet, smart phone, and furthermore, any electrical device capable of inputting digital signal. In practice, the signal provider can be advertiser or advertising agency, and the inputted digital signal can be advertising message, which includes one of image file, texture file, video file, and the combination thereof. In other words, an advertiser or advertising agency is able to input his advertisement to the remote server via the digital signal input device.

In this embodiment, an input software can be configured or installed in the digital signal input device 12 for the signal provider to input the digital signal S. The input software is capable of providing a convenient interface so that the signal provider can input the digital signal S easily. In another embodiment, the input software can also be configured or installed in the remote server, and then the remote server can provide the interface to the digital signal input device through the input software, so that the signal provider can use the interface on the digital signal input device to input the digital signal.

The mobile communicating device 14 can be one of various types of portable electrical device, such as smart phone, tablet with communicating function, and wearable electrical device such as smart glasses with communicating function, smart watch with communicating function, and smart helmet with communicating function. In recent years, the electronic technology has been developed rapidly, and the electrical device and wireless transmission technology have been combined to the wearable objects to form smart wearable object. These smart wearable objects can be used as the mobile communicating device in this invention. An application program can be configured or installed in the mobile communicating device 14, so as to control the mobile communicating device 14 to execute various functions in the message broadcasting system 1. In detail, the application program is capable of controlling the mobile communicating device 14 to communicate with the remote server 10 to receive the digital signal S and then send the digital signal S with an order. In practice, the mobile communicating device 14 can receive and send the digital signal S and order via any type of wireless communicating technology.

The mobile communicating device 14 can communicate with the image projecting device 18 and send the digital signal S and the order to the image projecting device 18 via wireless communicating technology. The image projecting device 18 can project the digital signal S on the display area according to the order. In practice, the carrier 16 can be one of car, motorcycle, bicycle, train, unmanned flying vehicle, and wearable object, and the display area can be at least one of ground, wall, ceiling of house, ceiling of car, and projection screen. Therefore, message broadcasting system 1 can project the digital signal S in various places in the city to achieve excellent advertising effect.

In this embodiment, the amounts of the mobile communicating devices 16, the carriers 16 and the image projecting device 18 are not limited to the amounts shown in FIG. 1. In practice, any mobile communicating device 14 provided with the application program is capable of communicating with the remote server 10 and some image projecting device 18 configured on the carrier 16, so as to receive the digital signal S and send it to the image projecting devices 18, and then the image projecting devices 18 can project the digital signal S on the carrier 16 (such as ceiling of car) or on the display area near the carrier 16. For example, a user of the mobile communicating device 14 (such as smart phone or tablet) can downloading and installing the application program in the mobile communicating device 14, and then the user can install the image projecting device 18 on his carrier 16 and connect the image projecting device 18 with the mobile communicating device 14. When the setting is completed, the user receives the advertising signal through the mobile communicating device 14, and then controls the carrier 16 through the mobile communicating device 14 to project the advertising signal on the carrier (such as ceiling of car) or on the display area near the carrier to obtain the advertising effect, so as to charge advertising income.

In this embodiment, the amount of the projecting devices 18 on a signal carrier 16 is not limited, but depends on the user's requirement. The image projecting devices 18 can be installed on different regions of the carrier 16 to project the digital signal S on different display areas. For example, the image projecting devices 18 can be respectively configured on the front, the side, the back, and the inside of a car, so as to project the digital image on the ground or wall near the front, the side and the back of the car, or on the ceiling of the car. Different image projecting devices 18 on the same carrier 16 or even different carriers 16 can be connected to the same mobile communicating device 14, so as to respectively control each of image projecting devices 18 to project the digital image S on different display areas by a signal mobile communicating device 14.

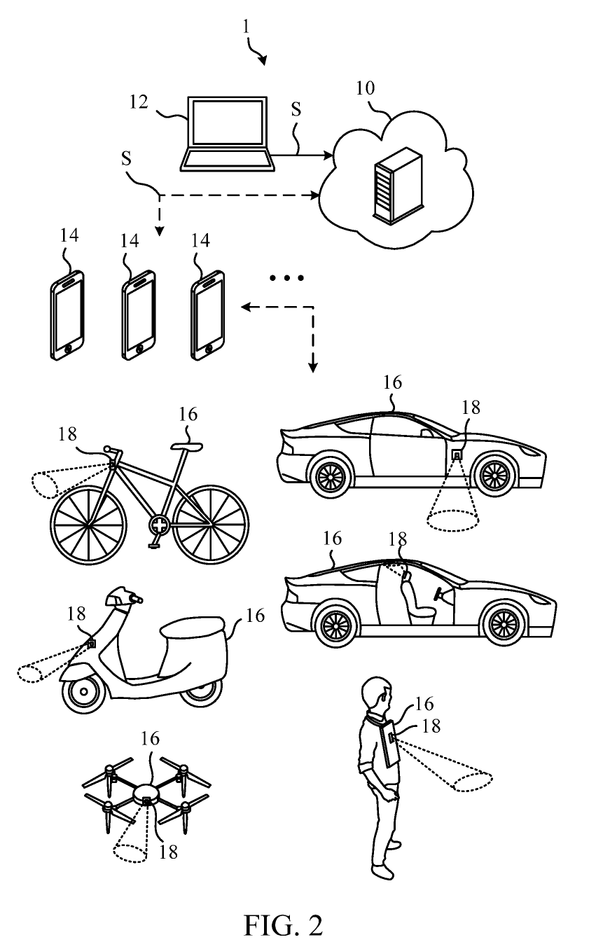

Please refer to FIG. 2. FIG. 2 is a schematic diagram illustrating different carriers 16 of the message broadcasting system 1 in FIG. 1. As shown in FIG. 1, the carriers 16 can be car, motorcycle, bicycle, train, unmanned aerial vehicle, or wearable object, and the image projecting devices 18 can be configured on the above-mentioned carriers 16 to project the advertising signal conveniently and widely. It should be noted that the wearable object covers the top of the user in the embodiment shown in FIG. 2, however, the wearable object is not limited to that in this embodiment. In practice, any kind of wearable object, such as helmet, hat, backpack, or shoes, can be the carrier 16 to configure the image projecting device 18 thereon.

Please refer to FIG. 1 again. As shown in FIG. 1, the image projecting device 18 is capable of recording the projecting times and the projecting durations, generating a signal according to the projecting times and the projecting durations, and sending the signal to the mobile communicating device 14. The mobile communicating device 14 generates a notification according to the received signal and sends it to the remote server 10. The remote server 10 checks the projecting times and the projecting durations according to the notification. In practice, the remote server 10 can further gather and calculate the projecting times and the projecting durations as the reference for calculating the advertising income.

Besides, the projecting times and projecting durations can be provided to another computing system as the statistical data. For example, the carrier 16 can be a taxi, and the image projecting device 18 on the taxi can generate and send a signal according to the projecting times and projecting durations to the managing system or the computing system of the taxi company which the taxi belongs to. The managing system or the computing system checks the projecting times and the projecting durations of the projections of the digital signal S by the image projecting device 18, and then gathers and calculates the projecting times and the projecting durations as the reference for calculating the advertising income.

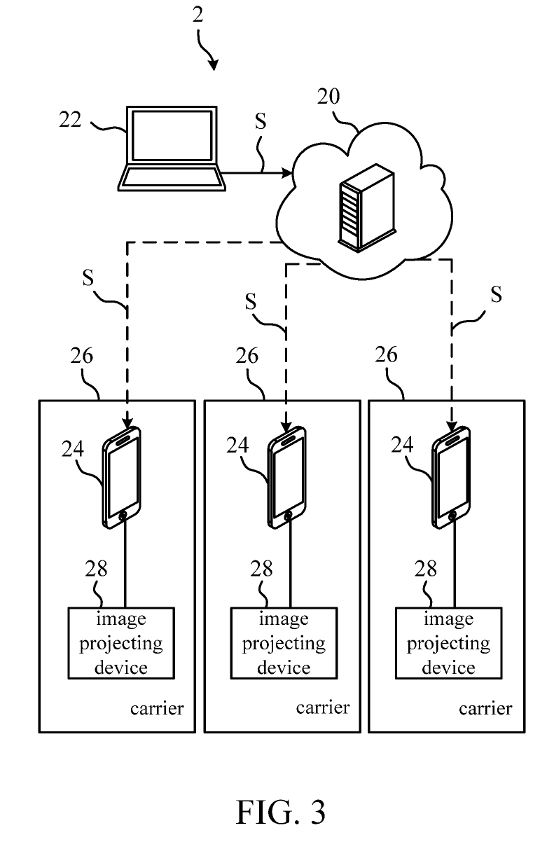

Please refer to FIG. 3. FIG. 3 is a schematic diagram illustrating a message broadcasting system 2 according to another embodiment of the invention. As shown in FIG. 3, the difference between this embodiment and the above embodiment shown in FIG. 1 is that the mobile communicating device 24 can be configured on the carrier 26 and connected to the image projecting device 28. The image projecting device 28 can be connected to the mobile communicating device 24 by wired connection since they are both configured on the carrier 26. It should be noted that the other elements of the message broadcasting system 2 are similar to the corresponding elements in the above-mentioned embodiment, so that they would not be described here again.

In this embodiment, the mobile communicating device 24 and the image projecting device 28 are configured on the carrier 26, and they form a smart device, such as smart car, smart motorcycle, smart bicycle, and robot. In practice, the application program in the mobile communicating device 24 can be used for planning the route of the smart device and controlling the image projecting device 28 to project the digital signal S on the route.

In practice, the user can use the mobile communicating devices in the above-mentioned embodiments to download various digital signals, and to control the projecting time and projecting sequence of the various digital signals projected by the image projecting device, so as to gain various advertising effect and further interact with the audience. For example, the smart device formed by the carrier and the mobile communicating device configured thereon is capable of capturing the image of the audience by the camera of the mobile communicating device at the same time, and the application program in the mobile communicating device is capable of judging the reaction of the audience to the digital signal and then request the corresponding digital signal from the remote server according to the reaction; or, the mobile communicating device is capable of pre-downloading various digital signal and choosing the corresponding one according to the reaction of the audience. The corresponding digital signal with the order would be sent to the image projecting device, so that the image projecting device would project the digital signal corresponding to the reaction of the audience to interact with the audience.

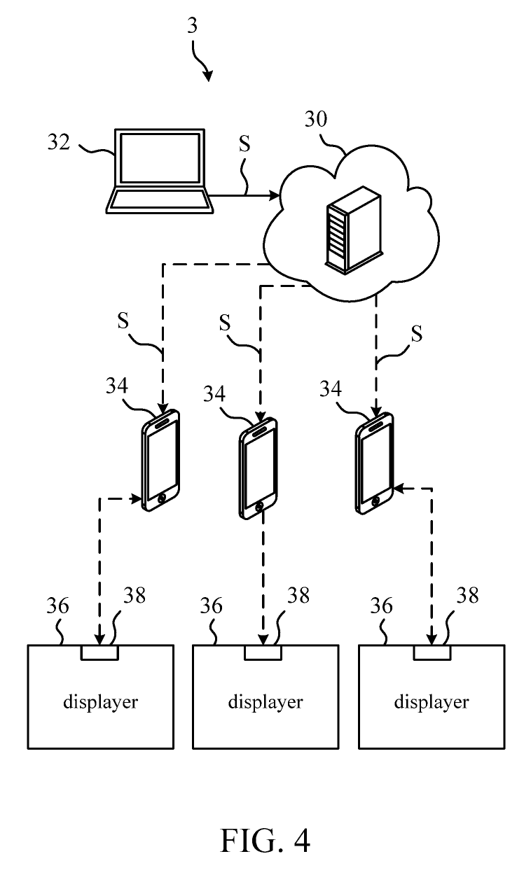

Please refer to FIG. 4. FIG. 4 is a schematic diagram illustrating a message broadcasting system 3 according to another embodiment of the invention. As shown in FIG. 4, the message broadcasting system 3 includes a remote server 30, a digital signal input device 32, at least one mobile communicating device 34, and at least one displayer 36, wherein the remote server 30 and the digital signal input device 32 are connected to each other, the remote server 30 communicates with the mobile communicating device 34, and the displayer 36 communicates with the mobile communicating device 34.

Similarly, the digital signal input device 32 can be used for inputting the digital signal S to the remote server 30 and the at least one mobile communicating device 34 can receive the digital signal S respectively from the remote server 30 in this embodiment. An application program is configured in the mobile communicating device 34 and controls the mobile communicating device 34 to receive the digital signal S and send the digital signal S with an order. The displayer 36 is capable of receiving the order and the digital signal S sent from the mobile communicating device 34 and displaying the digital signal S according to the order.

In this embodiment, the functions and structures of the remote server 30, the digital signal input device 32 and the mobile communicating device 34 of the message broadcasting system 3 are substantially the same with the corresponding devices in the above-mentioned embodiments, so that they would not be described here again. The displayer 36 could be LED panel, OLED panel, LCD panel, smart phone with display panel, computer or television, respectively configured in the indoor space, outdoor square, car, or on the surfaces of car, motorcycle, bicycle, unmanned flying vehicle or wearable object, so as to achieve the advertising effect anywhere.

Similarly, the displayer 36 is capable of generating a signal according to the display times and the display durations and sending the signal to the mobile communicating device 34. The mobile communicating device 34 sends a notification to the remote server 30 according to the signal, and the remote server 30 checks the display times and the display durations according to the notification. In practice, the remote server 30 can further gather and calculate the display times and the display durations as the reference for calculating the advertising income.

In practice, the mobile communicating device 34 can be connected to the displayer 36 to form a smart device. For example, the displayer 36 is configured on a car, and the car provides a connecting module for configuring the mobile communicating device 34 thereon and connecting the mobile communicating device 34 and the displayer 36, so as to form a smart car capable of auto-receiving and auto-displaying digital signal or advertising signal.

According to another embodiment, the above-mentioned message broadcasting system 3 can further include at least one receiving device 38, which is respectively connected to the at least one displayer 36. The receiving device 38 is capable of communicating with the mobile communicating device 34 to receive the digital signal S and the order, and sending the digital signal S and the order to corresponding displayer 36 for displaying. In practice, the receiving device 38 is capable of communicating with the mobile communicating device 34 via any type of wireless transmission technology.

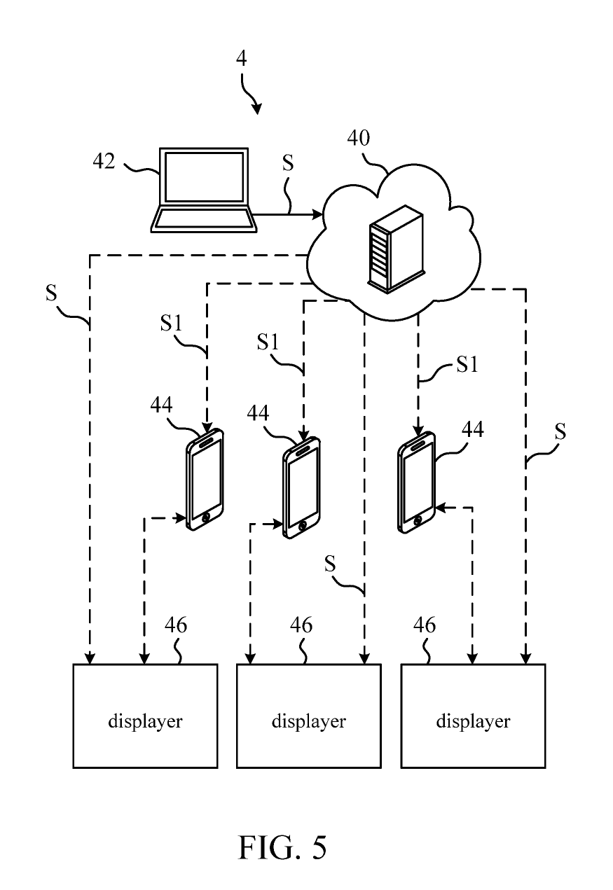

Please refer to FIG. 5. FIG. 5 is a schematic diagram illustrating a message broadcasting system 4 according to another embodiment of the invention. As shown in FIG. 5, the message broadcasting system 4 includes a remote server 40, a digital signal input device 42, at least one mobile communicating device 44, and at least one displayer 46. The remote server 40 and the digital signal input device 42 are connected to each other, so that a user or advertisement provider can input the digital signal S to the remote server 40 via the digital signal input device 42. The remote server 40 is capable of communicating with the mobile communicating device 44, and the displayer 46 is capable of communicating with the mobile communicating device 44 and the remote server 40.

The difference between this embodiment and the last embodiment is that the mobile communicating device 44 in this embodiment receives a first signal S1 from the remote server 44 and the application program in the mobile communicating device 44 sends an order to the corresponding displayer 46 according to the first signal, and then the displayer 46 requests and receives the digital signal S from the remote server 40 directly according to the first signal S1 to display the digital signal S according to the order. That is to say, the difference between this embodiment and the last embodiment is that the mobile communicating device 44 sends only the order to the display 46, and the displayer 46 receives the digital signal S directly from the remote server 40.

As described above, the message broadcasting system of the invention is capable of inputting the digital the digital signal to the remote server via the digital signal input device, and the mobile communicating device is capable of receiving the digital signal from the remote server and controlling the displayer or the image projecting device to display or project the digital signal near the carrier. Accordingly, the advertiser or advertising agency can input the advertisement easily, and the user of the mobile communicating device can remotely control the image projecting device on the carrier or the displayer via the mobile communicating device to display the advertisement anytime and anywhere, so as to achieve an excellent advertising effect and to decrease the cost at the same time.

Although the present invention has been illustrated and described with reference to the preferred embodiment thereof, it should be understood that it is in no way limited to the details of such embodiment but is capable of numerous modifications within the scope of the appended claims.

What is claimed is:

1. A message broadcasting system, comprising:
a remote server;
a digital signal input device, connected to the remote server, the digital signal input being adapted to input a digital signal to the remote server;
at least one mobile communicating device, communicating with the remote server and receiving the digital signal from the remote server, the at least one mobile communicating device having an application program to control the at least one mobile communicating device to send the digital signal and an order;
at least one carrier; and
at least one image projecting device, respectively configured on the at least one carrier, the at least one image projecting device being adapted to receive the order and the digital signal, and to project the digital signal on at least one display area according to the order.

2. The message broadcasting system of claim 1, wherein the digital signal comprises one of image file, texture file, and video file.

3. The message broadcasting system of claim 1, wherein the digital signal input device is one of desktop computer, tablet, and smart phone.

4. The message broadcasting system of claim 1, wherein an input software is configured in the digital signal input device for inputting the digital signal.

5. The message broadcasting system of claim 1, wherein an input software is configured in the remote server for the digital signal input device to input the digital signal.

6. The message broadcasting system of claim 1, wherein the at least one mobile communicating device is one of smart phone, tablet with communicating function, smart glasses with communicating function, smart watch with communicating function, and smart helmet with communicating function.

7. The message broadcasting system of claim 1, wherein the carrier is one of car, motorcycle, bicycle, unmanned flying vehicle, and wearable object.

8. The message broadcasting system of claim 1, wherein the at least one display area comprises at least one of ground, wall, ceiling of house, ceiling of car, and projection screen.

9. The message broadcasting system of claim 1, wherein the at least one image projecting device generates a signal according to the projecting times and the projecting durations, and sends the signal to the at least one mobile communicating device.

10. The message broadcasting system of claim 9, wherein the at least one mobile communicating sends a notification to the remote server according to the signal, and the remote server checks the projecting times and the projecting durations according to the notification.

11. The message broadcasting system of claim 1, wherein the at least one image projecting device generates a signal according to the projecting times and the projecting durations, and sends the signal to a computing system for the computing system checking the projecting times and the projecting durations.

12. The message broadcasting system of claim 1, wherein the at least one mobile communicating device is configured on the at least one carrier and connected to the at least one image projecting device.

13. The message broadcasting system of claim 12, wherein the at least one carrier, the at least one mobile communicating device, and the at least one image projecting device form at least one smart device, and the least one smart device is one of smart car, smart motorcycle, smart bicycle, and robot.

14. A message broadcasting system, comprising:
a remote server;
a digital signal input device, connected to the remote server, the digital signal input being adapted to input a digital signal to the remote server;
at least one mobile communicating device, communicating with the remote server and receiving the digital signal from the remote server, the at least one mobile communicating device having an application program to control the at least one mobile communicating device to send the digital signal and an order;
at least one displayer, communicating with the at least one mobile communicating device to receiving the order and the digital signal, the at least one displayer displaying the digital signal on at least one display area according to the order.

15. The message broadcasting system of claim 14, wherein the digital signal comprises one of image file, texture file, and video file.

16. The message broadcasting system of claim 14, wherein the digital signal input device is one of desktop computer, tablet, and smart phone.

17. The message broadcasting system of claim 14, wherein an input software is configured in the digital signal input device for inputting the digital signal.

18. The message broadcasting system of claim 14, wherein an input software is configured in the remote server for the digital signal input device to input the digital signal.

19. The message broadcasting system of claim 14, wherein the at least one mobile communicating device is one of smart phone, a tablet with communicating function, a smart glasses with communicating function, a smart watch with communicating function, and smart helmet with communicating function.

20. The message broadcasting system of claim 14, wherein the at least one displayer is one of LED panel, OLED panel, LCD panel, smart phone with display panel, computer, and television.

21. The message broadcasting system of claim 14, wherein the at least one displayer generates a signal according to the display times and the display durations, and sends the signal to the at least one mobile communicating device.

22. The message broadcasting system of claim 21, wherein the at least one mobile communicating sends a notification to the remote server according to the signal, and the remote server checks the display times and the display durations according to the notification.

23. The message broadcasting system of claim 14, wherein the at least one mobile communicating device and the at least one displayer form at least one smart device.

24. The message broadcasting system of claim 14, further comprising at least one receiving device connected to the at least one displayer, the receiving device communicating with the at least one mobile communicating device to receive the order and the digital signal and to send them to the at least one displayer.

25. A message broadcasting system, comprising:
a remote server;
a digital signal input device, connected to the remote server, the digital signal input being adapted to input a digital signal to the remote server;
at least one mobile communicating device, communicating with the remote server and receiving a first signal from the remote server, the at least one mobile communicating device having an application program to control the at least one mobile communicating device to send an order according to the first signal;
at least one displayer, communicating with the at least one mobile communicating device and the remote server, the at least one displayer receiving the order from the at least one mobile communicating device, receiving the digital signal from the remote server according to the order, and displaying the digital signal according to the order.

26. The message broadcasting system of claim 25, wherein the at least one displayer generates a second signal according to the display times and the display durations, and sends the second signal to the at least one mobile communicating device.

27. The message broadcasting system of claim 26, wherein the at least one mobile communicating sends a notification to the remote server according to the second signal, and the remote server checks the display times and the display durations according to the notification.
